(19) United States
(12) Patent Application Publication
(10) Pub. No.: US 2026/0268054 A1
(43) Pub. Date: Sep. 10, 2026

(54) Circuit design method and electronic device executing circuit design method

(71) Applicant: REALTEK SEMICONDUCTOR CORPORATION, HSINCHU (TW)

(72) Inventor: YEN-LIN PENG, HSINCHU (TW)

(21) Appl. No.: 19/553,786

(22) Filed: Mar. 2, 2026

(30) Foreign Application Priority Data
Mar. 4, 2025 (TW) 114107959

(51) Int. Cl. G06F 30/3312; G06F 30/392

(52) U.S. Cl. CPC G06F 30/3312; G06F 30/392

(57) ABSTRACT

A circuit design method is executed by an electronic device and includes the following steps: performing an IR drop analysis based on a circuit placement data; sorting multiple cells according to the IR drops to generate a candidate list; selecting a candidate cell from the candidate list; swapping the candidate cell; and performing a power consumption-based cell swapping process.

### BACKGROUND OF THE INVENTION

### 1. Field of the Invention

The present invention generally relates to a circuit design method, and more particularly, to the handling of IR drops (voltage drops) at the backend of the circuit design.

### 2. Description of Related Art

Power consumption analysis is one of the processes in electronic circuit design. Reference is made to FIG. 1, which shows the conventional power consumption analysis diagram. The diagram contains multiple low power consumption cells Ca, multiple medium power consumption cells Cb, and multiple high power consumption cells Cc. The power consumption of the low power consumption cell Ca is less than that of the medium power consumption cell Cb, and the power consumption of the medium power consumption cell Cb is less than that of the high power consumption cell Cc. The threshold voltage of the low power consumption cell Ca is greater than that of the medium power consumption cell Cb, and the threshold voltage of the medium power consumption cell Cb is greater than that of the high power consumption cell Cc.

The path 101 passes through multiple low power consumption cells Ca, multiple medium power consumption cells Cb, and a high power consumption cell Cc. The power consumption-based cell swapping process typically reduces the overall power consumption of an electronic device by swapping the high power consumption cell Cc on paths whose time slack is greater than 0 to a medium power consumption cell Cb or a low power consumption cell Ca.

In the prior art, the IR drop issue is typically addressed only after a power consumption analysis. However, addressing the IR drop issue too late often causes complex timing issues and routing issues, and solving timing issues and routing issues is quite time-consuming. Therefore, addressing the IR drop issue in advance helps reduce the complexity and time cost of an electronic circuit design.

### SUMMARY OF THE INVENTION

In view of the issues of the prior art, an object of the present invention is to provide a circuit design method and an electronic device for executing the circuit design method, so as to make an improvement to the prior art.

According to one aspect of the present invention, an electronic device is provided. The electronic device is configured to execute a circuit design method. The circuit design method includes a power consumption-based cell swapping process. The electronic device includes a memory and a computing circuit. The memory is configured to store a circuit placement data and a plurality of codes and/or program instructions. The computing circuit is coupled to the memory and configured to execute the plurality of codes and/or program instructions to perform the following steps: performing an IR drop analysis based on the circuit placement data; sorting, according to IR drops, a plurality of cells to generate a candidate list; selecting a candidate cell from the candidate list; swapping the candidate cell; and performing the power consumption-based cell swapping process.

According to another aspect of the present invention, a circuit design method is provided. The circuit design method includes the following steps: performing an IR drop analysis based on a circuit placement data; sorting, according to IR drops, a plurality of cells to generate a candidate list; selecting a candidate cell from the candidate list; swapping the candidate cell; and executing a power consumption-based cell swapping process.

The technical means embodied in the embodiments of the present invention can solve at least one of the problems of the prior art. Therefore, compared to the prior art, the present invention can reduce the complexity and time cost of an electronic circuit design.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows the conventional power consumption analysis diagram.

FIG. 2 is the functional block diagram of an electronic device according to an embodiment of the present invention.

FIGS. 3A-3C are flowcharts of a circuit design method according to an embodiment of the present invention.

FIG. 4 is the IR drop analysis diagram according to an embodiment of the present invention.

FIG. 5 is the schematic diagram of a candidate list according to an embodiment of the present invention.

FIG. 6 is the schematic diagram illustrating the determination of the threshold voltage of the to-be-swapped cells according to an embodiment of the present invention.

FIG. 7 is the IR drop analysis diagram according to another embodiment of the present invention.

FIGS. 8A and 8B are schematic diagrams of the list of unswappable cells according to an embodiment of the present invention.

FIGS. 9A and 9B are schematic diagrams of the list of to-be-swapped cells according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a circuit design method and an electronic device executing the circuit design method. On account of that some or all elements of the electronic device could be known, the detail of such elements is omitted provided that such detail has little to do with the features of this disclosure, and that this omission nowhere dissatisfies the specification and enablement requirements. Some or all of the processes of the circuit design method may be implemented by software and/or firmware and can be executed by electronic device or its equivalent. A person having ordinary skill in the art can choose components or steps equivalent to those described in this specification to carry out the present invention, which means that the scope of this invention is not limited to the embodiments in the specification.

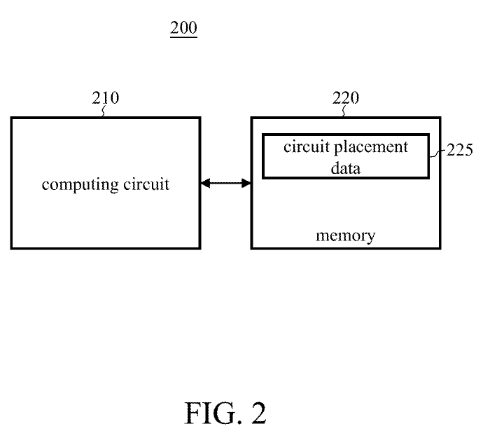

Reference is made to FIG. 2, which is a functional block diagram of an electronic device according to an embodiment of the present invention. The electronic device 200 includes the computing circuit 210 and the memory 220. The electronic device 200 may be a general-purpose computer, or a special-purpose computer specifically designed for conducting electronic circuit design. In some embodiments, the computing circuit 210 may be a circuit or electronic component with program execution capability, such as a central processing unit (CPU), a microprocessor, a microcontroller unit, an Application Specific Integrated Circuit (ASIC), or an equivalent circuit. The computing circuit 210 implements all or some of the functions of the electronic device 200, including but not limited to those discussed below, by executing multiple codes and/or program instructions stored in the memory 220.

The memory 220 stores the circuit placement data 225. The circuit placement data 225 includes an automatic placement and routing (APR) database and a function pattern, and the APR database has not yet executed the conventional power consumption-based cell swapping process.

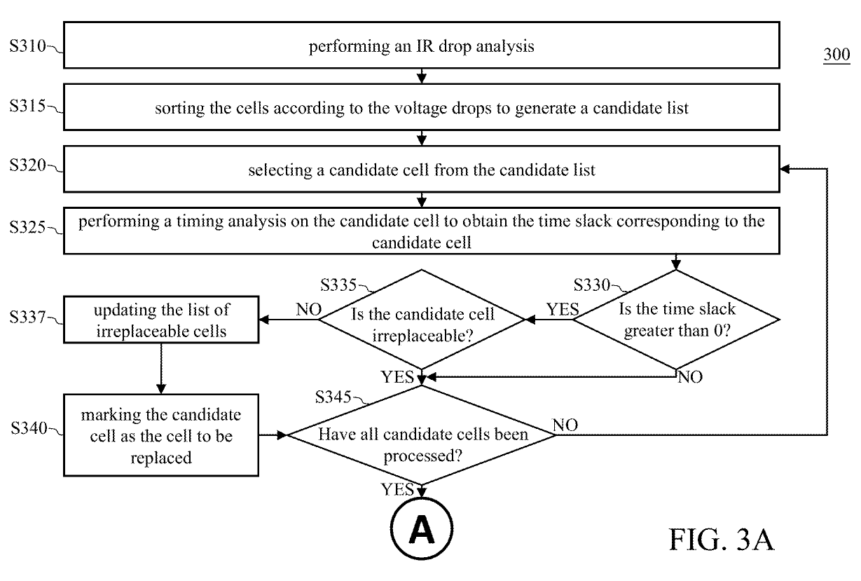

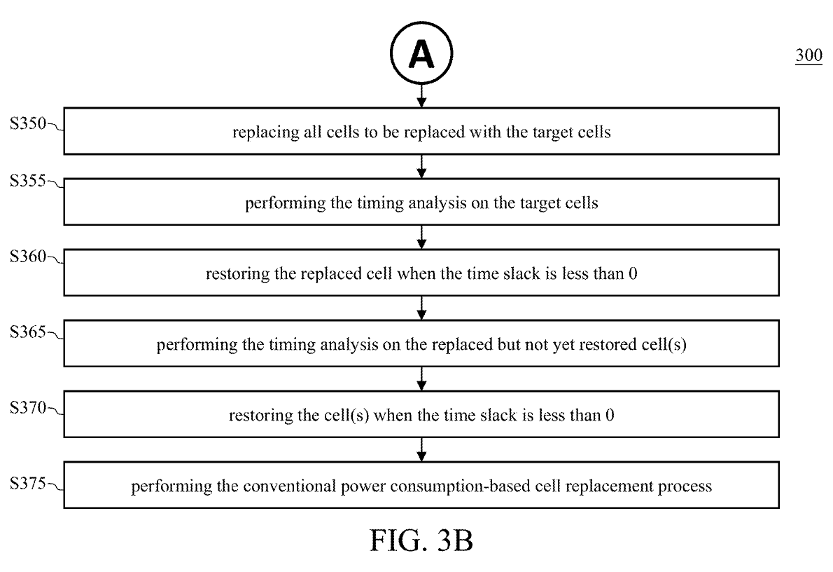

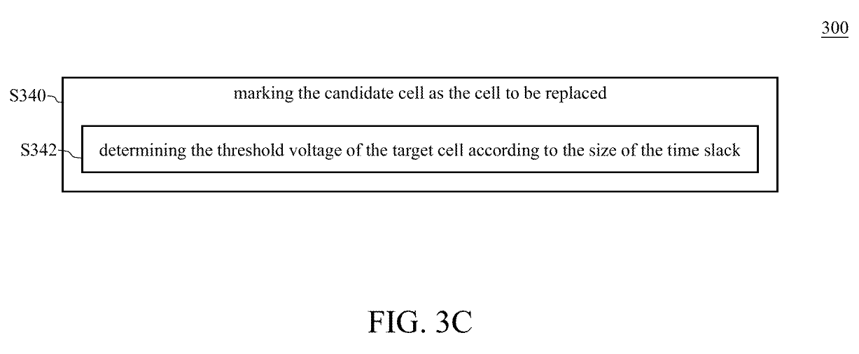

Reference is made to FIGS. 3A-3C, which illustrate the flowcharts of the circuit design method 300 according to an embodiment of the present invention. The circuit design method 300, which is used for the backend processing of the circuit design, can be executed by the computing circuit 210 and includes the following steps.

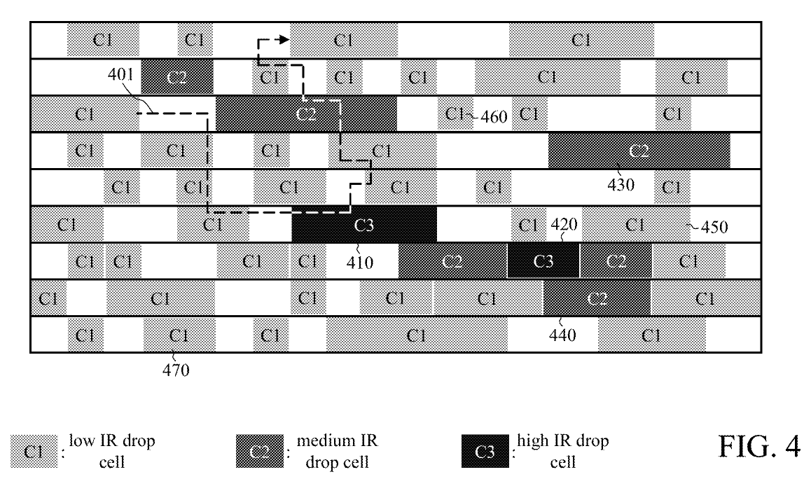

Step S310: Performing an IR drop analysis on the circuit placement based on the circuit placement data 225 to obtain the IR drop analysis diagram. Reference is made to FIG. 4, which is the IR drop analysis diagram according to an embodiment of the present invention. The diagram contains multiple low IR drop cells C1, multiple medium IR drop cells C2, and multiple high IR drop cells C3. The voltage drop of the low IR drop cell C1 is less than that of the medium IR drop cell C2, and the voltage drop of the medium IR drop cell C2 is less than that of the high IR drop cell C3.

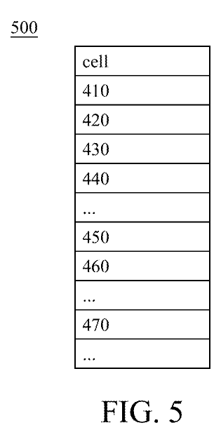

Step S315: Sorting the cells according to the voltage drops to generate a candidate list. Reference is made to FIG. 5, which is a schematic diagram of a candidate list 500 according to an embodiment of the present invention. In some embodiments, the candidate list 500 is arranged in the order of voltage drop from large to small. That is to say, the voltage drop of the cell 410 is the largest, followed in order by the cell 420, the cell 430, the cell 440, …, the cell 450, the cell 460, …, the cell 470, ….

In some embodiments, the computing circuit 210 excludes the flip-flops and the clock cells in step S315. That is to say, the candidate cells in the candidate list 500 are neither a flip-flop nor a clock cell.

Step S320: Selecting a candidate cell from the candidate list 500. For example, the computing circuit 210 selects one from the candidate list 500 in FIG. 5 as a candidate cell, following a top-down order where the voltage drop decreases from large to small.

Step S325: Performing a timing analysis (e.g., static timing analysis (STA)) on the candidate cell to obtain the time slack corresponding to the candidate cell. Referring to FIG. 4, since the cell 410 is located on the path 401, the time slack corresponding to the cell 410 is the time slack of the path 401. The calculation of time slack is well known to people having ordinary skill in the art, so further elaboration is omitted for brevity.

Step S330: Determining whether the time slack is greater than 0. If YES, then the flow proceeds to step S335; otherwise, the flow proceeds to step S345. More specifically, the computing circuit 210 determines whether to swap the candidate cell based on the size of the time slack. If the time slack is less than or equal to 0, the computing circuit 210 does not swap the candidate cell. If the time slack is greater than 0, then the computing circuit 210 further performs step S335 to determine whether to swap the candidate cell. It should be noted that swapping a candidate cell to a target cell may refer to modifying one or more characteristics of the candidate cell (including, but not limited to, a threshold voltage).

Step S335: Determining whether the candidate cell is unswappable. In some embodiments, the computing circuit 210 determines whether the candidate cell is in the list of unswappable cells. If the candidate cell is in the list of unswappable cells (i.e., step S335 is YES), then the flow proceeds to step S345; otherwise, the flow proceeds to step S337.

Step S337: Updating the list of unswappable cells. More specifically, the computing circuit 210 updates the list of unswappable cells by adding all the cells on the path (e.g., the path 401) where the candidate cell (e.g., the cell 410) is located to the list of unswappable cells. Regarding the list of unswappable cells, a further discussion will be provided below with reference to FIGS. 7, 8A, 8B, 9A, and 9B.

Step S340: Marking the candidate cell as the to-be-swapped cell. More specifically, the computing circuit 210 adds a to-be-swapped cell (e.g., the cell 410) and a path where the cell is located (e.g., the path 401) to a list of to-be-swapped cells. Regarding the list of to-be-swapped cells, a further discussion will be provided below with reference to FIGS. 7, 8A, 8B, 9A, and 9B. Step S340 includes a sub-step S342 (see FIG. 3C).

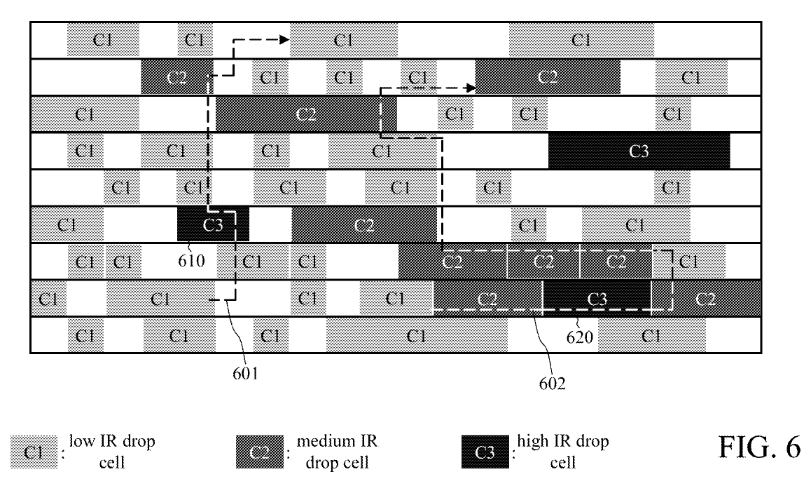

Step S342: Determining the threshold voltage of the to-be-swapped cell according to the size of the time slack. In some embodiments, when the time slack is greater (smaller), the threshold voltage of the to-be-swapped cell is greater (smaller). Reference is made to FIG. 6, which is the schematic diagram illustrating the determination of the threshold voltage of the to-be-placed cell according to an embodiment of the present invention. The candidate cell 610 and the candidate cell 620 are located on the path 601 and the path 602, respectively. Assuming that the time slacks of the path 601 and the path 602 are S1 and S2, respectively, and 0 < S2 < Sth < S1 (where Sth is a predetermined reference value), the computing circuit 210 determines that the candidate cell 610 is the to-be-swapped cell and can be swapped to become a high threshold voltage cell, and the candidate cell 620 is the to-be-swapped cell and can be swapped to become a medium threshold voltage cell. Swapping a to-be-swapped cell with sufficient time slack directly to a high threshold voltage cell (rather than a medium threshold voltage cell) can reduce the number of timing analyses (note that timing analysis is quite time-consuming). Therefore, step S342 helps save time.

Step S345: Determining whether all candidate cells in the candidate list 500 have been processed. If YES, then the flow proceeds to steps S350 to S375 in FIG. 3B; otherwise, the flow proceeds to step S320 to select the next candidate cell.

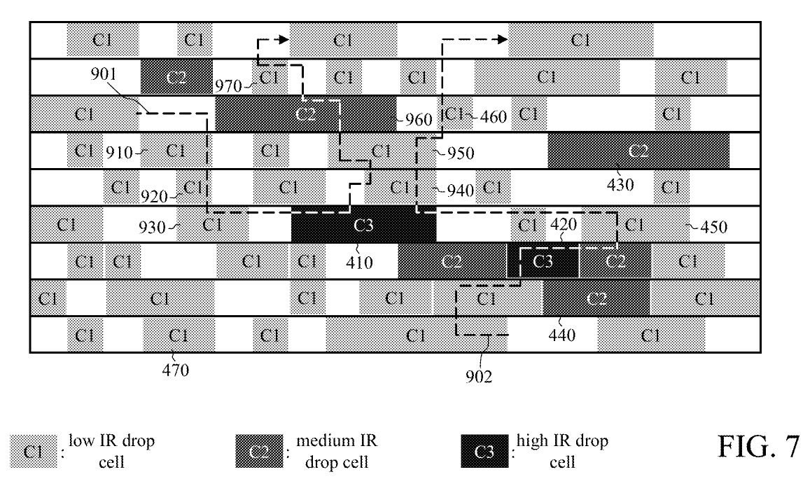

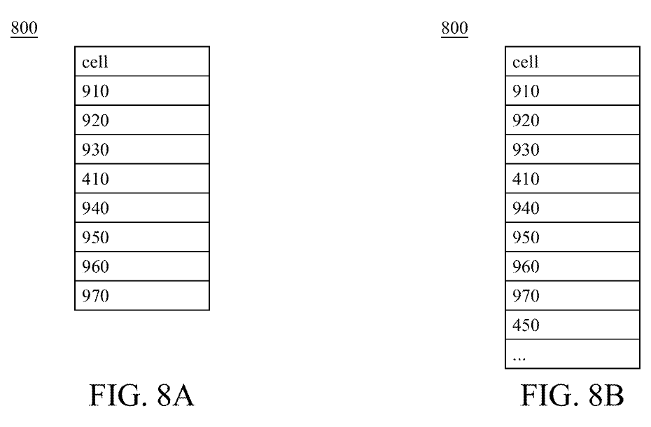

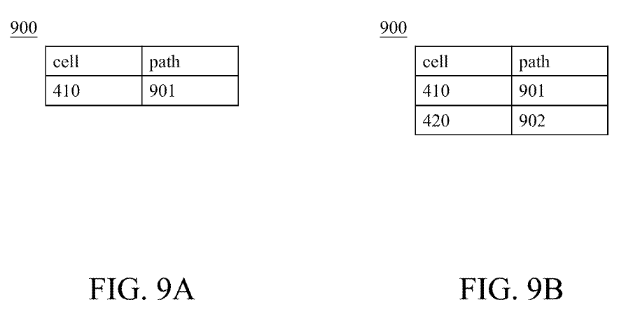

Reference is made to FIGS. 7, 8A, 8B, 9A, and 9B. FIG. 7 is the IR drop analysis diagram according to another embodiment of the present invention. FIGS. 8A and 8B are schematic diagrams of the list of unswappable cells 800 according to an embodiment of the present invention. FIGS. 9A and 9B are schematic diagrams of the list of to-be-swapped cells 900 according to an embodiment of the present invention. The following uses FIGS. 7, 8A, 8B, 9A, and 9B as examples to explain steps S330 to S340 in FIG. 3A again.

As shown in FIG. 7, in addition to the cell 410, there are also the cell 910, the cell 920, the cell 930, the cell 940, the cell 950, the cell 960, and the cell 970 on the path 901. In addition to the cell 420 and the cell 450, there are also the cell 410, the cell 940, the cell 950, and the cell 460 on the path 902.

Assuming that the current candidate cell is the cell 410, the time slack of the path 901 is greater than 0 (step S330 is YES) and the cell 410 is not in the list of unswappable cells (step S335 is NO), the computing circuit 210 adds all the cells on the path 901 (i.e., the cells 410 and 910 to 970) to the list of unswappable cells 800 (as shown in FIG. 8A) (step S337), and then marks the candidate cell 410 as the to-be-swapped cell (see FIG. 9A) (step S340). Because the cell 420 in the candidate list 500 has not been processed (step S345 is NO), the computing circuit 210 then selects the cell 420 as the candidate cell (step S320). Reference is made to FIG. 7. Assuming that the time slack of the path 902 where the cell 420 is located is greater than 0 (step S330 is YES), since the cell 420 is not in the list of unswappable cells 800 shown in FIG. 8A (step S335 is NO), the computing circuit 210 adds all the cells on the path 902 (including, but not limited to, the cell 450) to the list of unswappable cells 800 (refer to FIG. 8B) (step S337), and then marks the candidate cell 420 as the to-be-swapped cell (refer to FIG. 9B) (step S340). The computing circuit 210 repeats the above steps until all cells in the candidate list 500 are processed.

Reference is made to FIG. 3B.

Step S350: Swapping all to-be-swapped cells to the high threshold voltage cells determined in Step S342. More specifically, in this step, the computing circuit 210 swaps all cells in the list of to-be-swapped cells with their respective high threshold voltage cells. For example (refer to FIG. 7), the computing circuit 210 swaps the cell 410 (a low threshold voltage cell) with a medium threshold voltage cell, and the cell 420 (a low threshold voltage cell) with a high threshold voltage cell.

Step S355: Performing the timing analysis on the cell(s) which has/have been swapped to medium or high threshold voltage in the previous step to obtain the corresponding time slack.

Step S360: Restoring the swapped cell when the time slack is less than 0. For example (referring to FIG. 7), if the time slack of the path 901 becomes less than 0 after the cell 410 is swapped to a medium threshold voltage cell, then the computing circuit 210 restores the cell 410 to its original low threshold voltage cell in this step to avoid an error. Conversely, if the time slack of the path 901 is greater than or equal to 0, the computing circuit 210 does not restore the cell 410. This step can prevent the time slack of a path from becoming less than 0 after a cell on it is swapped.

Step S365: Performing the timing analysis on the swapped but not yet restored cell(s). Continuing the above example (refer to FIG. 7), since the cell 420 has been swapped but not restored, the computing circuit 210 performs the timing analysis on the cell 420 in this step.

Step S370: Restoring the cell(s) when the time slack is less than 0. Continuing the above example (refer to FIG. 7), if the time slack of the path 902 where the cell 420 is located is less than 0, then the computing circuit 210 restores the cell 420 in this step. Conversely, if the time slack of the path 902 is greater than or equal to 0, then the computing circuit 210 does not restore the cell 420.

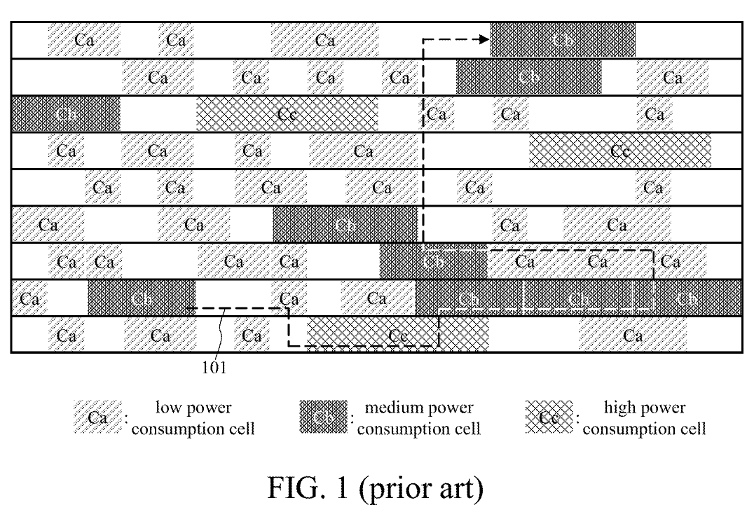

Step S375: Performing the conventional power consumption-based cell swapping process, that is, swapping cell(s) based on the power consumption-based analysis (refer to FIG. 1 and its discussion).

Note that, in some embodiments, step S365 and step S370 can be omitted to save time.

Note that if the computing circuit 210 finds that the time slacks of all paths are greater than 0 after performing step S355, then the computing circuit 210 does not perform step S360.

Since a person having ordinary skill in the art can appreciate the implementation detail and the modification thereto of the present method invention through the disclosure of the device invention, repeated and redundant description is thus omitted. Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device configured to execute a circuit design method comprising a power consumption-based cell swapping process, the electronic device comprising:
a memory configured to store a circuit placement data and a plurality of codes and/or program instructions; and
a computing circuit coupled to the memory and configured to execute the plurality of codes and/or program instructions to perform following steps:
performing an IR drop analysis based on the circuit placement data;
sorting, according to IR drops, a plurality of cells to generate a candidate list;
selecting a candidate cell from the candidate list;
swapping the candidate cell; and
performing the power consumption-based cell swapping process.

2. The electronic device of claim 1, wherein the computing circuit further performs following steps:
performing a timing analysis on the candidate cell to obtain a time slack corresponding to the candidate cell; and
deciding whether to swap the candidate cell according to the time slack.

3. The electronic device of claim 2, wherein the computing circuit further performs following steps:
when the time slack is greater than a value, determining whether the candidate cell can be swapped according to a list of unswappable cells;
wherein when the candidate cell is not in the list of unswappable cells, the candidate cell can be swapped.

4. The electronic device of claim 3, wherein the candidate cell is located on a path of the circuit placement data, there is a plurality of first cells on the path, and the computing circuit further performs following steps:
updating the list of unswappable cells by adding the candidate cell and the plurality of first cells to the list of unswappable cells.

5. The electronic device of claim 3, wherein the step of swapping the candidate cell is to swap the candidate cell to a target cell, and the computing circuit further performs following steps:
determining a threshold voltage of the target cell according to the time slack.

6. The electronic device of claim 5, wherein when the time slack is greater than a reference value, the threshold voltage is a first threshold voltage; when the time slack is less than the reference value, the threshold voltage is a second threshold voltage; the first threshold voltage is greater than the second threshold voltage.

7. The electronic device of claim 1, wherein the computing circuit further performs following steps:
after swapping the candidate cell to a target cell, performing a timing analysis on the target cell to obtain a time slack; and
when the time slack is less than a value, restoring the candidate cell.

8. The electronic device of claim 1, wherein the step of selecting the candidate cell from the candidate list is to select the candidate cell in an order of IR drop from largest to smallest.

9. The electronic device of claim 1, wherein the step of swapping the candidate cell is to swap the candidate cell to a target cell, and a first threshold voltage of the target cell is greater than a second threshold voltage of the candidate cell.

10. A circuit design method, comprising:
performing an IR drop analysis based on a circuit placement data;
sorting, according to IR drops, a plurality of cells to generate a candidate list;
selecting a candidate cell from the candidate list;
swapping the candidate cell; and
performing a power consumption-based cell swapping process.

11. The method of claim 10 further comprising:
performing a timing analysis on the candidate cell to obtain a time slack corresponding to the candidate cell; and
deciding whether to swap the candidate cell according to the time slack.

12. The method of claim 11 further comprising:
when the time slack is greater than a value, determining whether the candidate cell can be swapped according to a list of unswappable cells;
wherein when the candidate cell is not in the list of unswappable cells, the candidate cell can be swapped.

13. The method of claim 12, wherein the candidate cell is located on a path of the circuit placement data, there is a plurality of first cells on the path, and the method further comprises:
updating the list of unswappable cells by adding the candidate cell and the plurality of first cells to the list of unswappable cells.

14. The method of claim 12, wherein the step of swapping the candidate cell is to swap the candidate cell to a target cell, and the method further comprises:
determining a threshold voltage of the target cell according to the time slack.

15. The method of claim 14, wherein when the time slack is greater than a reference value, the threshold voltage is a first threshold voltage; when the time slack is less than the reference value, the threshold voltage is a second threshold voltage; the first threshold voltage is greater than the second threshold voltage.

16. The method of claim 10 further comprising:
after swapping the candidate cell to a target cell, performing a timing analysis on the target cell to obtain a time slack; and
when the time slack is less than a value, restoring the candidate cell.

17. The method of claim 10, wherein the step of selecting the candidate cell from the candidate list is to select the candidate cell in an order of IR drop from largest to smallest.

18. The method of claim 10, wherein the step of swapping the candidate cell is to swap the candidate cell to a target cell, and a first threshold voltage of the target cell is greater than a second threshold voltage of the candidate cell.
